(19) United States
(12) Patent Application Publication
(10) Pub. No.: US 2023/0236543 A1
(43) Pub. Date: Jul. 27, 2023

(54) AUTOMATIC THREE-DIMENSIONAL PRESENTATION FOR HYBRID MEETINGS

(71) Applicant: Microsoft Technology Licensing, LLC, Redmond, WA (US)

(72) Inventors: Rolly SETH, Redmond, WA (US); Omar AMIN, Redmond, WA (US)

(21) Appl. No.: 17/586,416

(22) Filed: Jan. 27, 2022

(51) Int. Cl. G03H 1/08; G06F 3/0482

(52) U.S. Cl. CPC G03H 1/08; G06F 3/0482; G03H 2210/32; G03H 2210/33

(57) ABSTRACT

Systems and methods are directed to automatically generating a three-dimensional (3D) holographic presentation from a two-dimensional (2D) slide presentation. A network system receives an indication to generate the 3D holographic presentation, which causes automatic generation of the 3D holographic presentation by the network system. In response to receiving the indication, the network system accesses the 2D slide presentation from a user device associated with a presenter and accesses, from a mapping database, a plurality of mappings that indicate how to convert elements of each slide of the 2D slide presentation into a 3D format. The network system then transforms elements of each slide from a 2D format into the 3D format based on the plurality of mappings. The 3D holographic presentation is generated from the transformed elements by blending the transformed elements with a background and/or real-world image data captured by an image capture device.

### TECHNICAL FIELD

The subject matter disclosed herein generally relates to presentations. Specifically, the present disclosure addresses systems and methods that automatically creates three-dimensional holographic presentations from a two-dimensional slide presentation.

### BACKGROUND

A hybrid workforce is becoming more prevalent. For example, some individuals will want to watch a presentation on their computer or laptop, while other individuals will want to watch the presentation using a virtual reality (VR)/augmented reality (AR) device (e.g., a VR headset) that provides a three-dimensional (3D) view. However, a presenter that creates a slide presentation for two-dimensional (2D) display, has no mechanism to share the 2D slide presentation with viewers at 3D devices. Typically, the presenter will need to create a separate 3D presentation for these viewers.

### BRIEF DESCRIPTION OF THE DRAWINGS

Some embodiments are illustrated by way of example and not limitation in the figures of the accompanying drawings.

FIG. 1 is a diagram illustrating a network environment suitable for automatically creating a three-dimensional (3D) holographic presentation from a two-dimensional (2D) slide presentation, according to some example embodiments.

FIG. 2 is a diagram illustrating components of an artificial intelligence engine, according to some example embodiments.

FIG. 3 is a diagram illustrating transmission of data between various components in the network environment, according to some example embodiments.

FIG. 4 is a flowchart illustrating operations of a method for automatically creating a 3D holographic presentation for display, according to some example embodiments.

FIG. 5 is a flowchart illustrating operations of a method for transforming slides of a 2D slide presentation into a 3D format, according to some example embodiments.

FIG. 6 is a block diagram illustrating components of a machine, according to some example embodiments, able to read instructions from a machine-storage medium and perform any one or more of the methodologies discussed herein.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

In a hybrid workforce where users are accessing presentations using different types of client devices that provide two-dimensional (2D) format and three-dimensional (3D) format, mechanisms are need to efficiently and easily provide a presentation formatted to the display requirements of each client device. Along with display requirements, there is also market shortcoming on real-time collaboration (working on a deck together) between 2D and 3D environments and on how to create, test, and see what a user in a different environment is seeing (e.g., how a presenter in 2D screen sees what a person in a holographic environment is seeing).

Conventionally, a presenter that creates a two-dimensional (2D) slide presentation would need to create a separate three-dimensional (3D) presentation for 3D devices because of the differences in architecture. For example, a slide of the 2D presentation may appear opaque on a physical screen of a presenter, however, the 3D presentation may need the slide to be semitransparent. Further still, the presenter typically cannot view what a 3D presentation would look like on their 2D device, thus making it difficult for the presenter to (manually) create or edit the 3D presentation.

In the context of example embodiments, the 3D presentations are holographic or metaverse presentations. Thus, example embodiments automatically create 3D holographic presentations from a 2D slide presentation (also referred to herein as a “slide deck”). In some embodiments, the 3D holographic presentation (also referred to herein as a “3D presentation”) is an abstraction of slides on a background (e.g., a desktop background, screen background) of the presenter device. In some embodiments, the 3D presentation includes real-world image data (e.g., from a camera) that is incorporated with the slides with or without the background.

Thus, example embodiments are directed to automatically generating a three-dimensional (3D) holographic presentation from a two-dimensional (2D) slide presentation. A network system receives an indication to generate the 3D holographic presentation, which causes automatic generation of the 3D holographic presentation by the network system. In response to receiving the indication, the network system accesses the 2D slide presentation from a user device associated with a presenter and accesses, from a mapping database, a plurality of mappings that indicate how to convert elements of each slide of the 2D slide presentation into a 3D format. The network system then transforms elements of each slide of the 2D slide presentation from a 2D format into the 3D format based on the plurality of mappings. The 3D holographic presentation is generated from the transformed elements by blending the transformed elements with a background and/or real-world image data captured by an image capture device. As a result, one or more of the methodologies described herein facilitate solving the technical problem of automatically creating a 3D holographic presentation from a 2D slide deck or presentation.

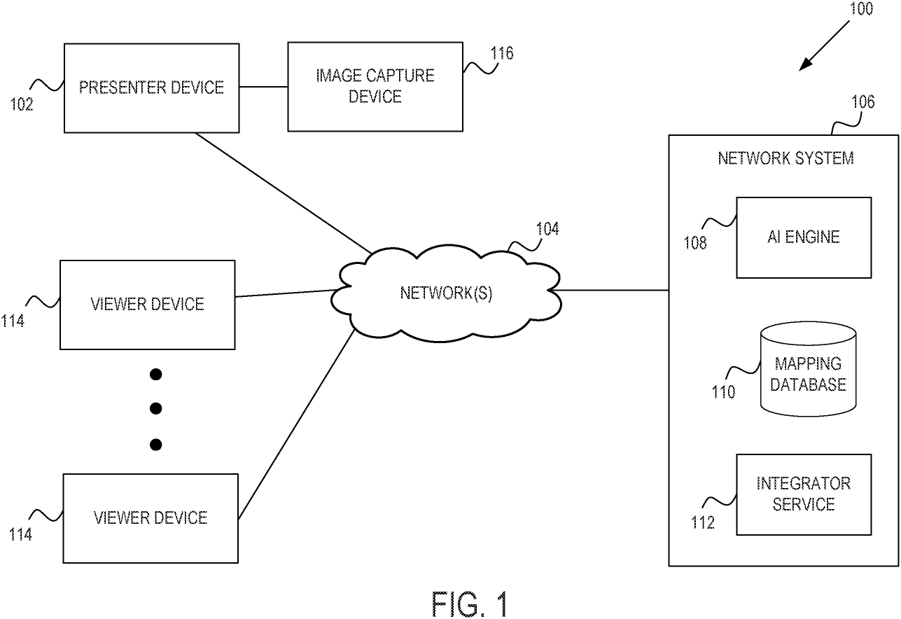

FIG. 1 is a diagram illustrating a network environment 100 suitable for automatically creating three-dimensional (3D) presentations from a 2D slide presentation, in accordance with example embodiments. A presenter device 102 is communicatively coupled, via a network 104, to a network system 106 that manages the automatic creation of a 3D presentation from a 2D slide deck or presentation. The presenter device 102 is a device of a presenter who is using one or more presentation applications provided by or associated with the network system 106 to create, edit, and/or display a presentation, such as a slide presentation. For example, the application can be PowerPoint.

In one embodiment, the presentation application on the presenter device 102 may default to transforming the 2D presentation into a 3D format for a particular type or category of devices. For example, the presentation application may default to creating 3D presentations for mixed reality devices, such as a HoloLens. In this embodiment, the device specification for both the presenter device 102 and the 3D devices (since it is known) is transmitted by the presenter device 102 to the network system 106. In other embodiments, the presenter may need to indicate the type of 3D device that will be viewing the presentation.

In example embodiments, the presentation application may provide a selectable icon or toggle button on a user interface displayed via the presentation application that allows the presenter to “turn on” the ability to create, view, and edit a 3D presentation on the presenter’s 2D presenter device 102. In one scenario, the presenter may have created a 2D presentation or slide deck. The presenter may then be asked to present it (or have it available for) a 3D device, such as a HoloLens device. In this scenario, the presenter does not have a 3D device, while some or all of the viewers will be viewing on their 3D devices. Since the presentation application includes the selectable icon or toggle button, the presenter can simply go to the presentation desktop (UI) and select the icon or toggle button to activate the transformation or conversion of the 2D presentation into a 3D version. Once activated, the presenter can update or change any user preference, provide 3D device specifications, if needed, and, on-the-fly, view and edit all the slides as 3D viewers will be viewing them but without having to change to a 3D device (e.g., a VR headset).

The selectable icon or toggle button allows the presenter to enable the 3D view or hide the 3D view simply by selecting the icon or toggle button. For example, clicking the button may make a slide appear translucent, change graphical content on fill, and/or change opacity of outline and borders. Colors may be changed based on mappings including user preferences, as will be discussed further below. Text styles may also change based on these mappings. The network system 106 performs all of these transformations, as will be discussed in more detail below, to create the 3D or holographic world/view on the presenter device 102, as well as for viewer devices 114.

The presentation device 102 may comprise, but is not limited to, a smartphone, tablet, laptop, multi-processor systems, microprocessor-based or programmable consumer electronics, game consoles, set-top boxes, a server, or any other communication device that can generate presentations and can access the network 104. In various embodiments, the presentation device 102 makes application program interface (API) calls to the network system 106 to create, edit, and/or display the 3D presentation.

In some embodiments, the presenter device 102 is coupled to, or includes, an image capture device 116 (e.g., a camera). Additionally or alternatively, the image capture device 116 is communicatively coupled, via the network 104, to the network system 106. The image capture device 116 captures images (e.g., of the user presenting, of a particular real-world environment) that can be used to augment the 2D slides to create a mixed reality 3D presentation. Mixed reality is an extension of augmented reality that allows for real world and virtual elements (e.g., elements of the slide) to interact. In one example, the image capture device 116 can be a HoloLens camera. Thus, example embodiments can automatically create a mixed reality 3D presentation from a 2D slide deck and image data captured by the image capture device 116. While example embodiments discuss a mixed reality 3D presentation, virtual reality and augment reality presentations are also contemplated. For simplicity, all of these types of 3D presentations will be referred to herein simply as “3D presentation(s).”

Depending on the form of the presenter device 102, any of a variety of types of connections and networks 104 may be used. For example, the connection may be Code Division Multiple Access (CDMA) connection, a Global System for Mobile communications (GSM) connection, or another type of cellular connection. Such a connection may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks, 5G networks). When such technology is employed, the network 104 includes a cellular network that has a plurality of cell sites of overlapping geographic coverage, interconnected by cellular telephone exchanges. These cellular telephone exchanges are coupled to a network backbone (e.g., the public switched telephone network (PSTN), a packet-switched data network, or other types of networks).

In another example, the connection to the network 104 is a Wireless Fidelity (Wi-Fi, IEEE 802.11x type) connection, a Worldwide Interoperability for Microwave Access (WiMAX) connection, or another type of wireless data connection. In some embodiments, the network 104 includes one or more wireless access points coupled to a local area network (LAN), a wide area network (WAN), the Internet, or another packet-switched data network. In yet another example, the connection to the network 104 is a wired connection (e.g., an Ethernet link) and the network 104 is a LAN, a WAN, the Internet, or another packet-switched data network. Accordingly, a variety of different configurations are expressly contemplated.

The network system 106 manages the automatic creation of the 3D presentation from the 2D slide presentation and images from the image capture device 116. In example embodiments, the network system 106 receives API calls, via the communication network 104 (e.g., the Internet, wireless network, cellular network, or a Wide Area Network (WAN)) from the presenter device 102, which causes the network system 106 to perform its operations. Thus, the network system 106 may comprise one or more servers (e.g., cloud servers) to perform its operations.

To enable the network system 106 to automatically create the 3D presentation, the network system 106 comprises an artificial intelligence (AI) engine 108, a mapping database 110, and an integrator service 112. The network system 106 may also include other components (not discussed herein) that are not relevant to example embodiments.

The AI engine 108 is configured to convert the 2D slide presentation into a 3D format. In various embodiments, the AI engine 108 receives API calls from the presenter device 102 that trigger the AI engine 108 to perform the conversions. The API calls can include (or can trigger the AI engine 108 to access) the 2D slide presentation or slide deck previously created by the presenter along with any preferences of the presenter.

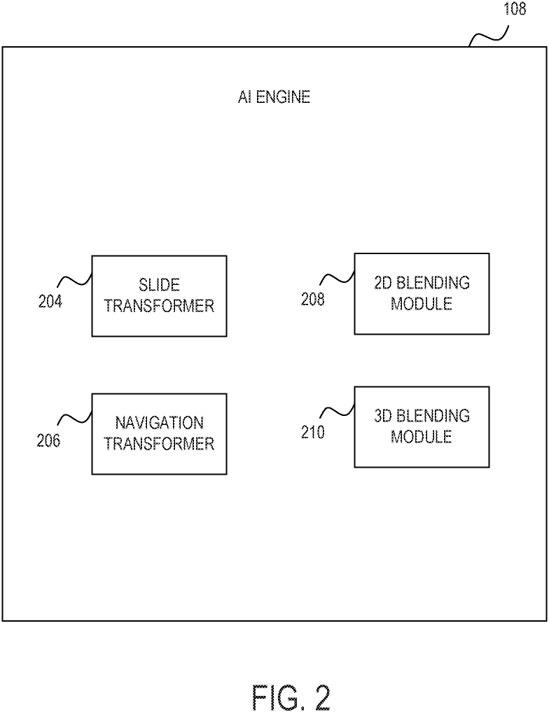

The AI engine 108 may also access data from the mapping database 110. The data comprises a plurality of mappings that indicate how to convert each element associated with the 2D slides into a 3D format or version. Using the mappings, the AI engine 108 automatically converts the elements in each slide of the 2D presentation into a 3D format. The AI engine 108 then blends the results of the mappings to create a 3D version of the slide. The AI engine 108 and its operations will be discussed in more detail in connection with FIG. 2 below.

The mapping database 110 includes the plurality of mappings that instruct the AI engine 108 how to convert each element of the slide into a 3D format (e.g., generate 3D elements). Thus, the mapping database 110 includes mappings that instruct how colors, text styles, opacity levels, background, and other visual elements of the 2D slides are to be converted into a 3D format. For example, one mapping can indicate that .gifs be made translucent. Another mapping may indicate that a particular text color in 2D should be changed to a different color and/or be made thirty percent brighter in the 3D format.

Furthermore, the mappings can include navigation conversions. For example, instead of using a mouse or keyboard arrows, gestures captured by the image capture device 116 are used. Additionally or alternatively, input modality may be changed with mappings. For example, a right arrow selection may correlate to a zoom in a 3D domain. Thus, the mappings can indicate how a particular interaction in transformed for the 3D environment.

The mappings include default mappings established by the network system 106. Additionally, or alternatively, some of the mappings may be customized by the presenter (or an administrator associated with the presenter). For instance, when a presenter triggers the creation of the 3D presentation, the presenter may be presented a user interface that allows the presenter to change one or more mapping attributes (e.g., a font style, color, background style). In other instances, the presenter can access and customize their preferences at any time.

In various embodiments, the mappings will be associated with specific devices. For example, a set of mappings may be for a Hololens device and a different set of mappings may be used for a different type of 3D device.

The integrator service 112 is a composition engine that is configured to render the 3D presentation for display on various user devices (e.g., presenter device 102 and viewer devices 114). In example embodiments, the integrator service 112, based on associated device specifications or identifications, knows which presentation (e.g., 2D or 3D) to provide and how to provide the presentations to the user devices. In some embodiments, the integrator service 112 is context-aware and can present the proper presentation format for each device. That is, the integrator service 112 efficiently and easily provides a presentation formatted to the display requirements of each client/viewing device.

Along with providing presentations based on display requirements, the integrator service 112 also allows for real-time collaboration between 2D and 3D environments and provides an ability to emulate other device specifications. This provides a quick way to see holographic presentation simulation in a non-holographic device (e.g., mimicking how a holographic presentation will look in a 2D screen device).

For a 3D presentation, the integrator service 112 may combine all of the 3D versions of the slides generated by the AI engine 108 to form the 3D slide presentation. The integrator service 112 also incorporates image data from the image capture device 116. The output of the integrator service 112 is a 3D mixed reality presentation that includes a 3D slide presentation blended with the image data (e.g., a video of the presenter, images of a real-world environment) that is viewable on the presenter device 102 as well as 3D devices. As such, the presenter, using their 2D presenter device 102, is essentially able to see what a 3D mixed reality presentation will look like without having to switch to a 3D device. More importantly, the presenter is able to preview and/or edit the 3D mixed reality presentation using their 2D presenter device 102.

During a live presentation, the presenter can present the slide deck of their presentation while viewing the 2D or 3D version on their presenter device 102. Concurrently, one or more viewer devices 114 that display in 3D will be presented the 3D version of the presentation, which may be a mixed reality presentation (e.g., the automatic conversion of the 2D version along with real-world image data from the image capture device 116 and/or from a background). Further still, the presenter can make edits to a slide on-the-fly during the presentation, and the edits will be automatically converted into a 3D format and shown in the 3D presentation.

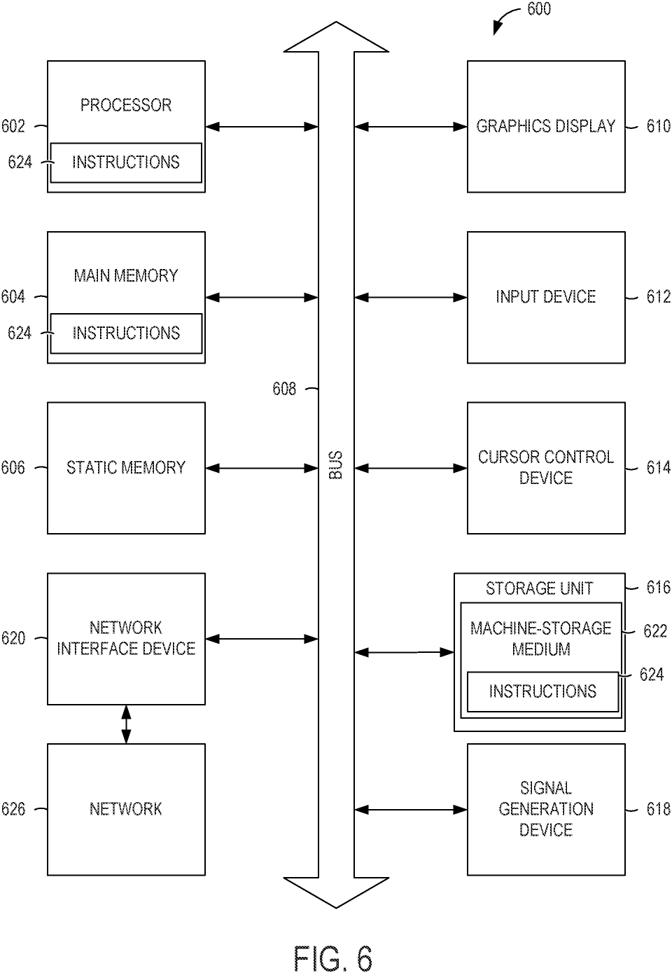

In example embodiments, any of the systems, devices, or services (collectively referred to as “components”) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system, device, or machine. For example, a special-purpose computer system able to implement any one or more of the methodologies described herein is discussed below with respect to FIG. 6, and such a special-purpose computer is a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the components illustrated in FIG. 1 or their functionality (e.g., the functionalities of the AI engine 108 and integrator service 112) may be combined, or the functions described herein for any single component may be subdivided among multiple components. Additionally, any number of presenter devices 102 and viewer devices 114 may be embodied within the network environment 100. While only a single network system 106 is shown, alternative embodiments contemplate having more than one network system 106 to perform the operations discussed herein (e.g., each localized to a particular region). Additionally, while the AI engine 108, mapping database 110, and the integrator service 112 are shown within the network system 106, one or more of these components can be in separate network systems or be located elsewhere in the network environment 100.

FIG. 2 is a diagram illustrating components of the artificial intelligence (AI) engine 108, according to some example embodiments. The AI engine 108 is configured to perform the automatic conversion of the 2D slide presentation into a 3D slide presentation that may incorporate a background of the presenter device 102. To enable these operations, the AI engine 108 comprises a slide transformer 204, a navigation transformer 206, a 2D blending module 208, and a 3D blending module 210 all configured to communicate with each other (e.g., via a bus, shared memory, or a switch). Alternative embodiments may comprise more or less components, combine the functions of some these components into a single component, or making some components optional.

In example embodiments, the AI engine 108 is context aware. Thus, the AI engine 108 can detect a type of the presenter device 102 (e.g., a virtual machine, x64). The AI engine 108 may also detect a type of the viewer devices 114. Additionally or alternatively, the AI engine 108 accesses device specifications that indicate the presenter device 102 and/or the viewer devices 114. Based on context of the devices (e.g., device specifications) and user preferences/personalized settings of the associate user of a device, the AI engine 108 adapts the presentation for display on each device by re-rendering the same slide deck for each type of device. In an alternative embodiment, the integrator service 112 is context aware and can adapt the presentation for display on each device.

The slide transformer 204 is configured to change a 2D visual element of a slide into a 3D version. The slide transformer 204 may change styles, background, text, and any other visual element of a slide based on mappings. As such, the AI engine 108 accesses mappings from the mapping database 110 and the slide transformer 204 converts or transforms various visual elements of each slide such, for example, opacity/transparency, colors, font style, and border styles, based on the mappings.

As an example, if a heads-up display (HUD) device is detected, the presentation slide background becomes 80% transparent, the slide text is converted to holographic colors such as neon blue, an outer glow is added to each of the graphics element in the slide be it shapes, text, graphs, tables, etc. This outer glow improves readability in HUD display. For images and embedded videos in the presentation slide, only a slight (e.g., 5-10%) transparency is added to still make it viewable in HUD. Here, HUD can be a Hololens headset or an augmented reality (AR) system/application including an AR phone application with real-world background shown behind the slide content.

The content for the AR and HUD devices can be 2D or 3D depending on preferences (e.g., user preferences) and there can be slight difference between 3D presentation and holographic presentations. Holographic presentations are for an AR-world like HUD (heads up display viewing) while VR is 3D with no holographic element required. In other words, since in holographic presentations, users can see real-world too, the content needs to be made transparent/translucent even if the content is not made 3D. While example embodiments have been primarily discussed in the context of holographic presentations, the example embodiments may also be used for 3D presentations without holographic elements.

Another mapping example can be for a virtual reality (VR) headset, where a real-world camera is not visible, and content is 3D digital/virtual only. Here, the slide content in VR can first assess the 3D environment in which the presentation is being shown. For instance, a virtual 3D conference room can detect a business environment and update the slide style accordingly.

Another mapping example can be a collaboration where multiple users have joined from various devices (e.g., one from Hololens/AR headset and another from 2D desktop screen/ monitor). Real-time, as a user is making changes to the presentation in the 3D world, a 2D-world user can see real-time changes in his monitor/2D screen. The 2D-world user can click on the holographic presentation button on his/her 2D screen and it will map a 3D presentation in the 2D screen. Here mapping will include blending between some elements (e.g., zoom in/out and application usage) as opaque and existing but other visual slide content will start showing as holographic (e.g., translucent) within the 2D screen. Note this is when the 2D-world user is trying to see 3D and holographic content.

Another example can be of people with accessibility needs. Here mapping can include specifications on contrast, large text, color blindness, alternate way to share visual information (e.g., auditory cue), etc. For example, if someone is color blind or need high contrast, the system can save those viewing preferences and, while mapping, makes a personalized copy for viewing for that particular user. Thus, various holographic users can have a different view of the same presentation while they all can simultaneously edit and collaborate on a slide.

The navigation transformer 206 is configured to transform input navigations. A presenter, on their 2D presenter device 102, may provide mouse and cursor movements. However, navigation on the 3D presentation is different because now there can be zooming and panning. Thus, the navigation transformer 206 may, based on a corresponding mapping, change the input navigation. For instance, instead of mouse inputs, gestures for a camera may be used. In another example, certain 2D inputs will map to a different 3D action (e.g., an up arrow key will cause a zoom, a left arrow key will cause a pan to the left).

In example embodiments, the 2D blending module 208 is configured to perform flat blending. In example embodiments, the 2D blending module 208 blends the desktop/screen background with underneath window(s). In some cases, the blending is performed by making a slide, which is usually opaque and white as a base, translucent. As such the 2D renderer 208 accesses (e.g., receives, retrieves) the desktop/screen background from an operating system of the presenter device 102 and performs the blending. In one embodiment, the 2D blended desktop may then be provided to the integrator service 112, which may render the 2D blended desktop for display on 2D devices.

The 3D blending module 210 is configured to performed 3D blending. In example embodiments, the 3D blending module 210 blends a 2D screen background (e.g., a desktop background) with the 3D elements of each slide (e.g., converted by the slide transformer 204) to provide a holographic effect (e.g., provide an opaque/glass effect) to each slide.

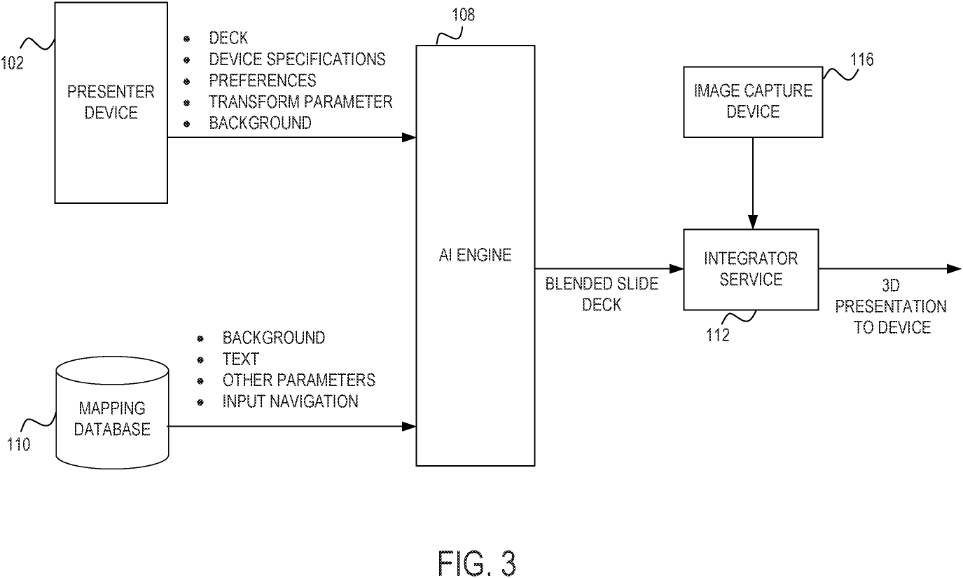

FIG. 3 is a diagram illustrating transmission of data between various components in the network environment 100, according to one example embodiment. The AI engine 108 and the integrator service 112 may be considered part of the “cloud.” The mapping database 110 may also be located in the cloud (e.g., at the network system 106). Alternatively, the mapping database 110 may be located elsewhere, such as at the presenter device 102.

The components of the cloud may access, from the presenter device 102, the slide deck to be transformed, device specifications of the presenter device 102, preferences of the presenter, a transform parameter (e.g., parameter to transform the slide deck from 2D to 3D), and/or a desktop/screen background. The preferences of the user may include changes to default or previously set mappings. In some cases, the device specification(s) of the viewer devices 114, if known, are also accessed by the components.

In cases where the presenter is creating and reviewing the slide deck in advance, the AI engine 108 will know the initial device (e.g., the presenter device 102) but may not know the final devices (e.g., viewer devices 114). In these cases, the presenter, via the presenter device 102, will need to inform the AI engine 108 that the presentation is for a particular type of device (e.g., for a HoloLens device), for example, by providing an indication (or device specification) of the final device.

In one embodiment, the presentation application on the presenter device 102 may default to creating the presentation for a particular type of category of devices (e.g., for HoloLens devices; for mixed reality devices). In this embodiment, the presentation application may provide the selectable icon or toggle button on a user interface displayed via the presentation application that allows the presenter to “turn on” the ability to create, view, and edit a 3D presentation on the presenter’s 2D presenter device 102.

The AI engine 108 also accesses mappings from the mapping database 110. These mappings indicated how to change an element of, or associated with, the 2D slide into a 3D format. For example, the mappings can indicate how to change a background of the slide (e.g., opacity, color), text on the slide (e.g., size, color, boldness, translucency amount, style), and other slide parameters (e.g., fill or opacity of outline and borders). The mappings also include input navigation and/or modality mappings.

Using all of the accessed information, the AI engine 108 transforms the 2D slide deck into 3D format. The transformation includes changing visual elements on the slides and/or navigational inputs based on the mappings. In some embodiments, the AI engine 108 blends the desktop/screen background with the other transformed elements from the slides to create holographic slides. The blended slide deck is then transmitted to the integrator service 112.

In some embodiments, the integrator service 112 receives image data of a real-world view of an environment captured by the image capture device 116. For example, the image data may be of the presenter presenting the presentation. The image data may be received directly from the image capture device 116 or be received via the presenter device 102 (in cases where the image device is coupled to or part of the presenter device 102). The integrator service 112 may incorporate the image data with the blended slide deck from the AI engine 108 to create the 3D holographic presentation.

The 3D holographic presentation is then transmitted for presentation. For a 2D presenter device 102, the integrator service 112 presents or provides editing capability to the 2D presenter device 102 such that the presenter can essentially view/edit a 3D version of the presentation on their 2D device. For 3D viewer devices 114, the integrator service 112 renders the presentation for display.

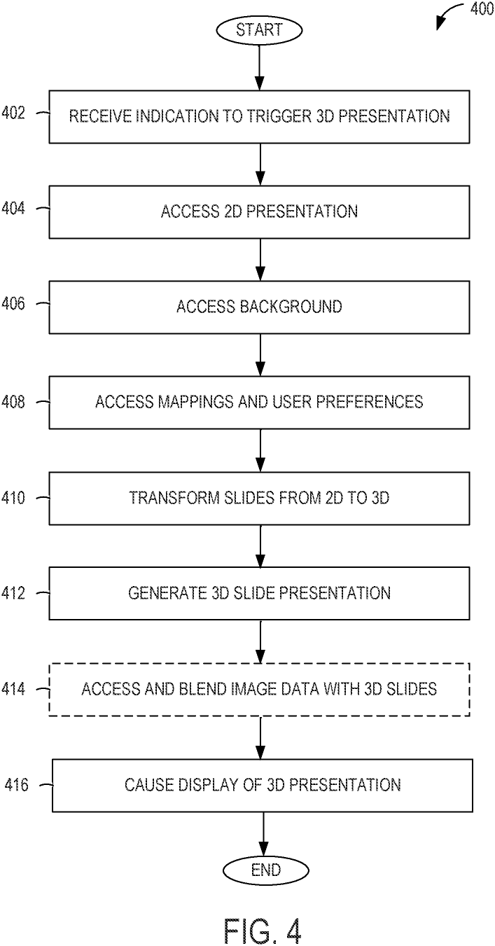

FIG. 4 is a flowchart illustrating operations of a method 400 for automatically creating a 3D holographic presentation from a 2D slide presentation, according to some example embodiments. Operations in the method 400 may be performed by the network system 106 in the network environment 100 described above with respect to FIG. 1 - FIG. 3. Accordingly, the method 400 is described by way of example with reference to these components in the network system 106. However, it shall be appreciated that at least some of the operations of the method 400 may be deployed on various other hardware configurations or be performed by similar components residing elsewhere in the network system 106. Therefore, the method 400 is not intended to be limited to these components.

In operation 402, an indication to trigger 3D presentation of the 2D slide deck is received. In some embodiments, the presentation application may provide a selectable icon or toggle button on a user interface that allows the presenter to “turn on” the ability to create, view, and edit a 3D presentation on the presenter’s 2D presenter device 102. In these embodiments, the presenter device 102 is configured to make API calls to the network system 106 to create the 3D presentation for display. These embodiments may occur when the presenter is preparing the 2D/3D presentation for later display.

In some embodiments, the indication to trigger 3D presentation may be received during a live presentation of the 2D slide deck. In these embodiments, the indication may be received from the viewer devices 114 requesting to display the 3D presentation. Alternatively, the indication may be received from the presenter device 102 requesting that the 3D presentation be made available for the viewer devices 114.

In operation 404, the network system 106 accesses the 2D presentation. In example embodiments, the AI engine 108 may access (e.g., receives, retrieves) the 2D slide deck from the presenter device 102.

In operation 406, the network system 106 accesses (e.g., receives, retrieves) a background (e.g., desktop or 2D screen background). In some embodiments, the 2D blending module 208 accesses the background from the operating system.

In operation 408, the network system 106 accesses mappings and user preferences. In example embodiments, the AI engine 108 (e.g., the slide transformer 204) accesses (e.g., receives, retrieves) a plurality of mappings from the mapping database 110. The mapping database 110 includes the plurality of mappings that instruct the AI engine 108 how to convert each element of the slide into a 3D format (e.g., generate 3D elements). Thus, the mapping database 110 includes mappings that instruct how colors, text styles, opacity levels, background, borders, images, videos, and other visual elements of the 2D slides are to be converted into a 3D format. The user preferences of the presenter may include changes to default or previously set mappings.

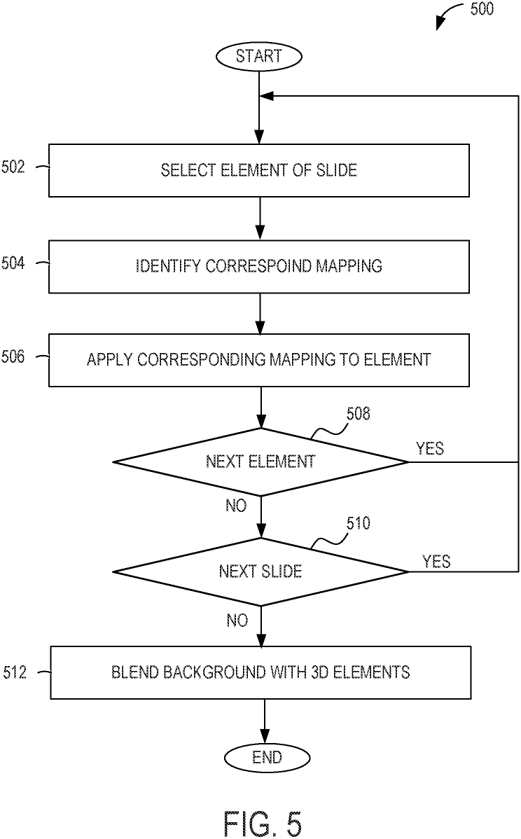

In operation 410, the AI engine 108 transforms each slide in the 2D slide deck from 2D format to 3D format. Operation 410 will be discussed in more detail in connection with FIG. 5 below.

In operation 412, the network system 106 generates the 3D slide presentation. In example embodiments, the integrator service 112 combines all of the 3D versions of the slides generated in operation 410 to form the 3D slide presentation or slide deck. In some cases, a Z-order layer (e.g., stacked layer of content) can be used in a slide. For example, text can be overlaid on an image from the 2D screen with some distance and depth to provide additional 3D effect on a 3D screen.

In operation 414, the network system 106 accesses and blends image data with the 3D slide presentation. In some embodiments, the integrator service 112 accesses (e.g., receives, retrieves) image data of a real-world view of an environment captured by the image capture device 116. For example, the image data may be of the presenter presenting the presentation. The integrator service 112 then incorporates the image data with the 3D slide deck to create a 3D holographic presentation. In embodiments where image data is not captured or used, operation 414 is optional or not performed.

In operation 416, the 3D presentation is displayed. On a 2D presenter device 102, the integrator service 112 presents or provides editing capability to the 2D presenter device 102 such that the presenter can essentially view/edit a 3D version of the presentation on their 2D device. For 3D viewer devices 114, the integrator service 112 renders the presentation for display.

FIG. 5 is a flowchart illustrating operations of a method 500 (operation 410) for transforming slides of a 2D slide presentation into 3D format, according to some example embodiments. Operations in the method 500 may be performed by the network system 106 in the network environment 100 described above with respect to FIG. 1 - FIG. 3. Accordingly, the method 500 is described by way of example with reference to these components in the network system 106. However, it shall be appreciated that at least some of the operations of the method 500 may be deployed on various other hardware configurations or be performed by similar components residing elsewhere in the network system 106. Therefore, the method 500 is not intended to be limited to these components.

In operation 502, the AI engine 108 selects an element of a slide to transform. In example embodiments, the slide transformer 206 selects the element of the slide that it will transform. Each slide may comprise a plurality of different elements that will need to be converted to 3D format. For example, the elements can include a slide background, text, borders, images, videos, and so forth.

In operation 504, the slide transformer 204 identifies a corresponding mapping for the selected slide element. The mapping instructs how to transform/convert the selected element into a 3D format. For example, if the selected element is a .gif shown on a slide, then the mapping provides instructions on how to format the .gif for 3D display.

In operation 506, the slide transformer 204 applies the corresponding mapping to the selected slide element. For example, if the mapping indicates that the .gif (the selected element) be made translucent, then the slide transformer 204 will make the .gif in the slide translucent.

In operation 508, a determination is made whether there is a next element in the slide to be transformed. If there is a next element, the method 500 returns to operation 502, where the next element is selected. If there is not a next element, the method 500 proceeds to operation 510.

In operation 510, a determination is made whether there is a next slide in the slide deck to transform. If there is a next slide, the method 500 returns to operation 502 where an element of the next slide is selected. If there is not a next slide, then the method proceeds to operation 512.

In operation 512, the 3D blending module 210 blends the desktop background with the formatted 3D elements for each slide to create a 3D slide. The 3D slide may have a holographic effect (e.g., provide an opaque/glass effect).

While the operations of FIG. 4 and FIG. 5 are shown in a particular order, alternative embodiments may practice the operations in a different order. For example, operation 512 may occur after all elements on a particular slide have been formatted (e.g., prior to operations 510). Additionally, one or more of the operations may be made optional in alternative embodiments.

FIG. 6 illustrates components of a machine 600, according to some example embodiments, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 6 shows a diagrammatic representation of the machine 600 in the example form of a computer device (e.g., a computer) and within which instructions 624 (e.g., software, a program, an application, an applet, an app, or other executable code) for causing the machine 600 to perform any one or more of the methodologies discussed herein may be executed, in whole or in part.

For example, the instructions 624 may cause the machine 600 to execute the flow diagrams of FIG. 4 to FIG. 5. In one embodiment, the instructions 624 can transform the general, non-programmed machine 600 into a particular machine (e.g., specially configured machine) programmed to carry out the described and illustrated functions in the manner described.

In alternative embodiments, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624 (sequentially or otherwise) that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The processor 602 may contain microcircuits that are configurable, temporarily or permanently, by some or all of the instructions 624 such that the processor 602 is configurable to perform any one or more of the methodologies described herein, in whole or in part. For example, a set of one or more microcircuits of the processor 602 may be configurable to execute one or more modules (e.g., software modules) described herein.

The machine 600 may further include a graphics display 610 (e.g., a plasma display panel (PDP), a light emitting diode (LED) display, a liquid crystal display (LCD), a projector, or a cathode ray tube (CRT), or any other display capable of displaying graphics or video). The machine 600 may also include an input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a sound card, an amplifier, a speaker, a headphone jack, or any suitable combination thereof), and a network interface device 620.

The storage unit 616 includes a machine-storage medium 622 (e.g., a tangible machine-storage medium) on which is stored the instructions 624 (e.g., software) embodying any one or more of the methodologies or functions described herein. The instructions 624 may also reside, completely or at least partially, within the main memory 604, within the processor 602 (e.g., within the processor’s cache memory), or both, before or during execution thereof by the machine 600. Accordingly, the main memory 604 and the processor 602 may be considered as machine-readable media (e.g., tangible and non-transitory machine-readable media). The instructions 624 may be transmitted or received over a network 626 via the network interface device 620.

In some example embodiments, the machine 600 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

### Executable Instructions and Machine-Storage Medium

The various memories (i.e., 604, 606, and/or memory of the processor(s) 602) and/or storage unit 616 may store one or more sets of instructions and data structures (e.g., software) 624 embodying or utilized by any one or more of the methodologies or functions described herein. These instructions, when executed by processor(s) 602 cause various operations to implement the disclosed embodiments.

As used herein, the terms “machine-storage medium,” “device-storage medium,” “computer-storage medium” (referred to collectively as “machine-storage medium 622”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 622 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magnetooptical disks; and CD-ROM and DVD-ROM disks. The terms machine-storage medium or media, computer-storage medium or media, and device-storage medium or media 622 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure The terms are defined to include both machine-storage media and signal media. Thus, the terms include both storage devices/media and carrier waves/modulated data signals.

The instructions 624 may further be transmitted or received over a communications network 626 using a transmission medium via the network interface device 620 and utilizing any one of a number of well-known transfer protocols (e.g., HTTP). Examples of communication networks 626 include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions 624 for execution by the machine 600, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-storage medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

### EXAMPLES

Example 1 is a method for automatically generating a three-dimensional (3D) holographic presentation from a two-dimensional (2D) slide presentation. The method comprises receiving, at a network system, an indication to generate a three-dimensional (3D) holographic presentation from a two-dimensional (2D) slide presentation, the indication causing automatic generation of the 3D holographic presentation by the network system; in response to receiving the indication, accessing, by the network system, the 2D slide presentation from a user device associated with a presenter; accessing, by the network system from a mapping database, a plurality of mappings that indicate how to convert elements of each slide of the 2D slide presentation into a 3D format; transforming, by the network system, elements of each slide of the 2D slide presentation from a 2D format into the 3D format based on the plurality of mappings; generating the 3D holographic presentation from the transformed elements; and causing presentation of the 3D holographic presentation.

In example 2, the subject matter of example 1 can optionally include wherein the indication to generate the 3D holographic presentation is generated by a selection of a one-click icon on a user interface of a presentation application at the user device.

In example 3, the subject matter of any of examples 1-2 can optionally include wherein the plurality of mappings includes user preferences established by the presenter via the user interface of the presentation application.

In example 4, the subject matter of any of examples 1-3 can optionally include wherein the plurality of mappings includes mappings that are specific to a viewer device that will be viewing the 3D holographic presentation in 3D.

In example 5, the subject matter of any of examples 1-4 can optionally include wherein the plurality of mappings includes navigation mappings that indicate navigation input conversions.

In example 6, the subject matter of any of examples 1-5 can optionally include wherein the generating the 3D holographic presentation comprises blending the transformed elements for each slide to generate a 3D version of each slide; and generating a 3D slide presentation from the 3D version of each slide.

In example 7, the subject matter of any of examples 1-6 can optionally include wherein the generating the 3D holographic presentation further comprises accessing image data from an image capture device, the image data comprising real-world images; and blending the image data with the 3D slide presentation.

In example 8, the subject matter of any of examples 1-7 can optionally include accessing, from an operating system of the user device, a background, wherein the generating the 3D slide presentation comprises blending the background with the 3D version of each slide.

In example 9, the subject matter of any of examples 1-8 can optionally include wherein the transforming elements of each slide comprises selecting an element of a slide to be transformed; identifying a mapping from the plurality of mappings that corresponds to the element; applying the identified mapping to the element to transform the element; and repeating the selecting, identifying, and applying for each additional element of the slide.

In example 10, the subject matter of any of examples 1-9 can optionally include wherein the causing presentation of the 3D holographic presentation comprises causing presentation of the 3D holographic presentation on the user device, the user device displaying the 3D holographic presentation in 2D.

In example 11, the subject matter of any of examples 1-10 can optionally include wherein the causing presentation of the 3D holographic presentation comprises detecting a viewer device that displays in 3D on which to present the 3D holographic presentation; and providing the 3D holographic presentation to the viewer device for display in 3D.

Example 12 is a system for automatically generating a three-dimensional (3D) holographic presentation from a two-dimensional (2D) slide presentation. The system comprises one or more hardware processors and a memory storing instructions that, when executed by the one or more hardware processors, cause the one or more hardware processors to perform operations comprising receiving an indication to generate a three-dimensional (3D) holographic presentation from a two-dimensional (2D) slide presentation, the indication causing automatic generation of the 3D holographic presentation by a network system; in response to receiving the indication, accessing the 2D slide presentation from a user device associated with a presenter; accessing, from a mapping database, a plurality of mappings that indicate how to convert elements of each slide of the 2D slide presentation into a 3D format; transforming elements of each slide of the 2D slide presentation from a 2D format into the 3D format based on the plurality of mappings; generating the 3D holographic presentation from the transformed elements; and causing presentation of the 3D holographic presentation.

In example 13, the subject matter of example 12 can optionally include wherein the indication to generate the 3D holographic presentation is generated by a selection of a one-click icon on a user interface of a presentation application at the user device.

In example 14, the subject matter of any of examples 12-13 can optionally include wherein the plurality of mappings includes navigation mappings that indicate navigation input conversions.

In example 15, the subject matter of any of examples 12-14 can optionally include wherein the generating the 3D holographic presentation comprises blending the transformed elements for each slide to generate a 3D version of each slide; and generating a 3D slide presentation from the 3D version of each slide.

In example 16 the subject matter of any of examples 12-15 can optionally include wherein the generating the 3D holographic presentation further comprises accessing image data from an image capture device, the image data comprising real-world images; and blending the image data with the 3D slide presentation.

In example 17, the subject matter of any of examples 12-16 can optionally include wherein the operations further comprise accessing, from an operating system of the user device, a background, wherein the generating the 3D slide presentation comprises blending the background with the 3D version of each slide.

In example 18, the subject matter of any of examples 12-17 can optionally include wherein the transforming elements of each slide comprises selecting an element of a slide to be transformed; identifying a mapping from the plurality of mappings that corresponds to the element; applying the identified mapping to the element to transform the element; and repeating the selecting, identifying, and applying for each additional element of the slide.

In example 19, the subject matter of any of examples 12-18 can optionally include wherein the causing presentation of the 3D holographic presentation comprises causing presentation of the 3D holographic presentation on the user device, the user device displaying the 3D holographic presentation in 2D.

Example 20 is a computer-storage medium comprising instructions which, when executed by one or more hardware processors of a machine, cause the machine to perform operations for automatically generating a three-dimensional (3D) holographic presentation from a two-dimensional (2D) slide presentation. The operations comprise receiving an indication to generate a three-dimensional (3D) holographic presentation from a two-dimensional (2D) slide presentation, the indication causing automatic generation of the 3D holographic presentation by a network system; in response to receiving the indication, accessing the 2D slide presentation from a user device associated with a presenter; accessing, from a mapping database, a plurality of mappings that indicate how to convert elements of each slide of the 2D slide presentation into a 3D format; transforming elements of each slide of the 2D slide presentation from a 2D format into the 3D format based on the plurality of mappings; generating the 3D holographic presentation from the transformed elements; and causing presentation of the 3D holographic presentation.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
receiving, at a network system, an indication to generate a three-dimensional (3D) holographic presentation from a two-dimensional (2D) slide presentation, the indication causing automatic generation of the 3D holographic presentation by the network system;
in response to receiving the indication, accessing, by the network system, the 2D slide presentation from a user device associated with a presenter;
accessing, by the network system from a mapping database, a plurality of mappings that indicate how to convert elements of each slide of the 2D slide presentation into a 3D format;
transforming, by the network system, elements of each slide of the 2D slide presentation from a 2D format into the 3D format based on the plurality of mappings;
generating the 3D holographic presentation from the transformed elements; and
causing presentation of the 3D holographic presentation.

2. The method of claim 1, wherein the indication to generate the 3D holographic presentation is generated by a selection of a one-click icon on a user interface of a presentation application at the user device.

3. The method of claim 2, wherein the plurality of mappings includes user preferences established by the presenter via the user interface of the presentation application.

4. The method of claim 1, wherein the plurality of mappings includes mappings that are specific to a viewer device that will be viewing the 3D holographic presentation in 3D.

5. The method of claim 1, wherein the plurality of mappings includes navigation mappings that indicate navigation input conversions.

6. The method of claim 1, wherein the generating the 3D holographic presentation comprises:
blending the transformed elements for each slide to generate a 3D version of each slide; and
generating a 3D slide presentation from the 3D version of each slide.

7. The method of claim 6, wherein the generating the 3D holographic presentation further comprises:
accessing image data from an image capture device, the image data comprising real-world images; and
blending the image data with the 3D slide presentation.

8. The method of claim 6, further comprising:
accessing, from an operating system of the user device, a background,
wherein the generating the 3D slide presentation comprises blending the background with the 3D version of each slide.

9. The method of claim 1, wherein the transforming elements of each slide comprises:
selecting an element of a slide to be transformed;
identifying a mapping from the plurality of mappings that corresponds to the element;
applying the identified mapping to the element to transform the element; and
repeating the selecting, identifying, and applying for each additional element of the slide.

10. The method of claim 1, wherein the causing presentation of the 3D holographic presentation comprises causing presentation of the 3D holographic presentation on the user device, the user device displaying the 3D holographic presentation in 2D.

11. The method of claim 1, wherein the causing presentation of the 3D holographic presentation comprises:
detecting a viewer device that displays in 3D on which to present the 3D holographic presentation; and
providing the 3D holographic presentation to the viewer device for display in 3D.

12. A system comprising:
one or more hardware processors; and
a memory storing instructions that, when executed by the one or more hardware processors, cause the one or more hardware processors to perform operations comprising:
receiving an indication to generate a three-dimensional (3D) holographic presentation from a two-dimensional (2D) slide presentation, the indication causing automatic generation of the 3D holographic presentation by a network system;
in response to receiving the indication, accessing the 2D slide presentation from a user device associated with a presenter;
accessing, from a mapping database, a plurality of mappings that indicate how to convert elements of each slide of the 2D slide presentation into a 3D format;
transforming elements of each slide of the 2D slide presentation from a 2D format into the 3D format based on the plurality of mappings;
generating the 3D holographic presentation from the transformed elements; and
causing presentation of the 3D holographic presentation.

13. The system of claim 12, wherein the indication to generate the 3D holographic presentation is generated by a selection of a one-click icon on a user interface of a presentation application at the user device.

14. The system of claim 12, wherein the plurality of mappings includes navigation mappings that indicate navigation input conversions.

15. The system of claim 12, wherein the generating the 3D holographic presentation comprises:
blending the transformed elements for each slide to generate a 3D version of each slide; and
generating a 3D slide presentation from the 3D version of each slide.

16. The system of claim 15, wherein the generating the 3D holographic presentation further comprises:
accessing image data from an image capture device, the image data comprising real-world images; and
blending the image data with the 3D slide presentation.

17. The system of claim 15, wherein the operations further comprise:
accessing, from an operating system of the user device, a background,
wherein the generating the 3D slide presentation comprises blending the background with the 3D version of each slide.

18. The system of claim 12, wherein the transforming elements of each slide comprises:
selecting an element of a slide to be transformed;
identifying a mapping from the plurality of mappings that corresponds to the element;
applying the identified mapping to the element to transform the element; and
repeating the selecting, identifying, and applying for each additional element of the slide.

19. The system of claim 12, wherein the causing presentation of the 3D holographic presentation comprises causing presentation of the 3D holographic presentation on the user device, the user device displaying the 3D holographic presentation in 2D.

20. A computer-storage medium comprising instructions which, when executed by one or more hardware processors of a machine, cause the machine to perform operations comprising:
receiving an indication to generate a three-dimensional (3D) holographic presentation from a two-dimensional (2D) slide presentation, the indication causing automatic generation of the 3D holographic presentation by a network system;
in response to receiving the indication, accessing the 2D slide presentation from a user device associated with a presenter;
accessing, from a mapping database, a plurality of mappings that indicate how to convert elements of each slide of the 2D slide presentation into a 3D format;
transforming elements of each slide of the 2D slide presentation from a 2D format into the 3D format based on the plurality of mappings;
generating the 3D holographic presentation from the transformed elements; and
causing presentation of the 3D holographic presentation.
